(19) United States
(12) Patent Application Publication
(10) Pub. No.: US 2017/0242372 A1
(43) Pub. Date: Aug. 24, 2017

(54) TUBULAR MEMBER, TRANSFER BELT, TRANSFER UNIT, AND IMAGE FORMING APPARATUS

(71) Applicant: FUJI XEROX CO., LTD., Tokyo (JP)

(72) Inventors: Kenji OMORI, Ebina-shi (JP); Fumio DAISHI, Ebina-shi (JP); Tomoo MATSUSHIMA, Ebina-shi (JP)

(73) Assignee: FUJI XEROX CO., LTD., Tokyo (JP)

(21) Appl. No.: 15/216,297

(22) Filed: Jul. 21, 2016

(30) Foreign Application Priority Data
Feb. 18, 2016 (JP) 2016-029174

(51) Int. Cl. B32B 9/04; G03G 15/01

(52) U.S. Cl. CPC G03G 15/162

(57) ABSTRACT

According to an aspect of the invention, a tubular member includes a siloxane-modified polyetherimide, a polyetherimide except the siloxane-modified polyetherimide, a polyether ether ketone, and a conductive material.

### CROSS-REFERENCE TO RELATED APPLICATIONS

This application is based on and claims priority under 35 USC 119 from Japanese Patent Application No. 2016-0029174 filed Feb. 18, 2016.

### BACKGROUND

### Technical Field

The present invention relates to a tubular member, a transfer belt, a transfer unit, and an image forming apparatus.

### SUMMARY

According to an aspect of the invention, there is provided a tubular member including: a siloxane-modified polyetherimide, a polyetherimide except the siloxane-modified polyetherimide, a polyether ether ketone, and a conductive material.

### BRIEF DESCRIPTION OF THE DRAWINGS

FIG. 1 is a perspective view schematically illustrating an example of a tubular member according to an exemplary embodiment;

FIG. 2 is a perspective view schematically illustrating an example of a transfer unit according to the exemplary embodiment; and

FIG. 3 is a configuration diagram schematically illustrating an example of an image forming apparatus according to the exemplary embodiment.

### DETAILED DESCRIPTION

Hereinafter, description will be given of an exemplary embodiment as an example of the invention with reference to accompanying drawings. In the following description, reference numerals will be omitted in some cases.

### Tubular Member

A tubular member according to the exemplary embodiment includes a siloxane-modified polyetherimide, a polyetherimide except the siloxane-modified polyether imide, a polyether ether ketone, and a conductive material. Fracture is not easily caused in the tubular member according to the exemplary embodiment in a case where the tubular member is repeatedly bent. The reasons are considered to be as follows though not clear.

In the following description, polyetherimide except a siloxane-modified polyetherimide will be simply referred to as “polyetherimide”, and a siloxane-modified polyetherimide and polyetherimide except the siloxane-modified polyetherimide will be collectively referred to as “all the polyetherimide components” in some cases. The characteristic that fracture is not easily caused in a case where the tubular member is repeatedly bent will be referred to as “durability against repeated bending” in some cases.

In a case of using an amorphous thermoplastic resin with excellent dimensional stability as a resin that forms a transfer belt, such as an intermediate transfer belt, in an image forming apparatus based on an electrophotographic system, it is necessary to blend a conductive material such as carbon black in order to obtain electric resistance necessary for transferring a toner image.

However, if the transfer belt is manufactured by using the amorphous thermoplastic resin and the conductive material, brittleness tends to appear since the resin forming the belt is an amorphous resin, and cracking tends to occur due to burden caused by repeated deformation. In addition, it is difficult to obtain long-term durability since blending of a conductive material such as carbon black increases hardness due to a reinforcing effect thereof and prevents stretching during deformation.

In contrast, the tubular member according to the exemplary embodiment contains three types of thermoplastic resins, namely a polyetherimide, a siloxane-modified polyetherimide, and a polyether ether ketone.

Polyetherimide is an amorphous thermoplastic resin having excellent dimensional stability.

The siloxane-modified polyetherimide surrounds the surface of the conductive material, such as carbon black, by intermolecular force at a siloxane bond portion and enhances dispersibility of the conductive material in the polyetherimide. In addition, the siloxane-modified polyetherimide exhibits flexibility due to a high degree of rotational freedom, and exhibits excellent bending resistance.

Since both the polyetherimide and the siloxane-modified polyetherimide are amorphous thermoplastic resins, displacement or aggregation of the conductive material due to folding of molecular chains during crystallization is not easily caused, and as a result, a dispersion state of the conductive material in the resin is not easily changed.

In contrast, the polyether ether ketone is a crystalline resin and has a crystal structure. Therefore, cracking by fatigue caused by repeated bending is not easily caused and propagated, and excellent durability against repeated bending is exhibited. The crystalline polyether ether ketone typically makes it difficult to secure the dispersibility of the conductive material such as carbon black, and in particular the dispersibility of the conductive material is secured as described above by including the siloxane-modified polyetherimide. The use of the polyether ether ketone brings about an effect that the siloxane-modified polyetherimide tends to be localized on the surface of the belt, which enhances releasability of the belt.

Since the polyetherimide component including an imide bond and an ether bond and the polyether ether ketone including a ketone bond and an ether bond exhibit high solubility, a tubular member with effects of the respective resin components may be obtained.

As described above, it is considered that the tubular member according to the exemplary embodiment may secure high dimensional stability of the amorphous resin, apply fatigue-resistant strength of the crystalline resin, and does not easily cause fracture in a case where bending is repeated, by including the amorphous resin (polyetherimide) with excellent dimensional stability, the amorphous resin (siloxane-modified polyetherimide) with excellent flexibility and conductive material dispersibility, and the crystalline resin (polyether ether ketone) with excellent fatigue-resistant strength.

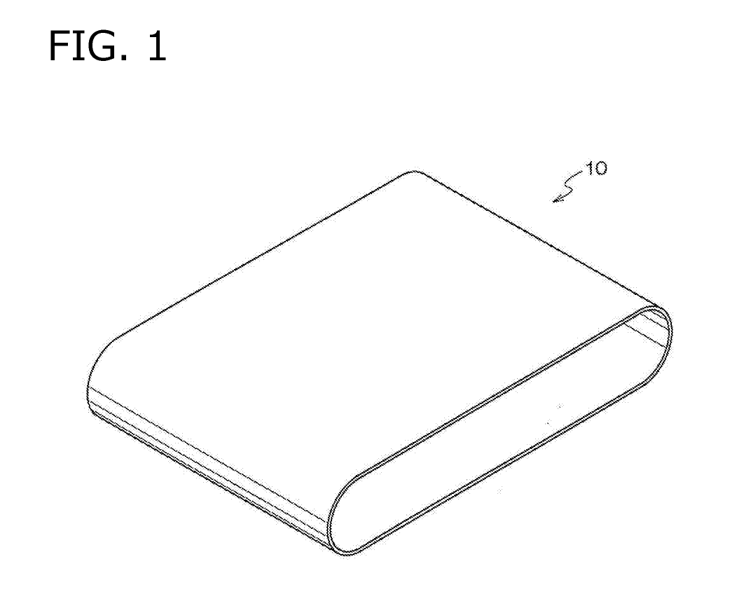

FIG. 1 is a perspective view schematically illustrating an example of the tubular member according to the exemplary embodiment. A tubular member 10 illustrated in FIG. 1 contains the siloxane-modified polyetherimide, the polyetherimide except a siloxane-modified polyetherimide, polyether ether ketone, and a conductive material. Hereinafter, description will be given of constituent materials of the tubular member 10 according to the exemplary embodiment. The tubular member will be referred to as a “tubular belt” in some cases.

### Polyetherimide Except Siloxane-Modified Polyetherimide

The polyetherimide except the siloxane-modified polyetherimide is polyetherimide that does not include siloxane bond and is a resin that contains an alicyclic or aromatic ether unit and a cyclic imide group as repeating units and has a melt-molding property.

Examples of the polyetherimide include a resulting object obtained by a polymerization reaction between dicarboxylic dianhydride including ether bond and diamine. That is, examples of the polyetherimide include polyetherimide that has at least a repeating unit structure derived from dicarboxylic dianhydride including ether bond and diamine, for example.

Examples of dicarboxylic dianhydride including ether bond includes 2,2-bis[4-(3,4-dicarboxyphenoxy)phenyl]propane dianhydride, 4,4′-bis(3,4-dicarboxyphenoxy)diphenylether dianhydride, 4,4′-bis(3,4-dicarboxyphenoxy)diphenyl sulfide anhydride, 4,4′-bis(3,4-dicarboxyphenoxy)benzophenone dianhydride, 4,4′-bis(3,4-dicarboxyphenoxy)diphenyl sulfone dianhydride, 2,2-bis[4-(2,3-dicarboxyphenoxy)phenyl]propane dianhydride, 4,4′-bis(2,3-dicarboxyphenoxy)diphenylether dianhydride, 4,4′-bis(2,3-dicarboxyphenoxy)diphenyl sulfide anhydride, 4,4′-bis(2,3-dicarboxyphenoxy)benzophenone dianhydride, 4,4′-bis(2,3-dicarboxyphenoxy)diphenyl sulfone dianhydride, 4-(2,3-dicarboxyphenoxy)-4′-(3,4-dicarboxyphenoxy)diphenyl-2,2-propane dianhydride, 4-(2,3-dicarboxyphenoxy)-4′-(3,4-dicarboxyphenoxy)diphenylether dianhydride, 4-(2,3-dicarboxyphenoxy)-4′-(3,4-dicarboxyphenoxy)diphenyl sulfide anhydride, 4-(2,3-dicarboxyphenoxy)-4′-(3,4-dicarboxyphenoxy)benzophenone dianhydride, and 4-(2,3-dicarboxyphenoxy)-4′-(3,4-dicarboxyphenoxy)diphenyl sulfone dianhydride. One kind of the above dicarboxylic dianhydride may be used alone, or two or more kinds selected therefrom may be used in combination.

Examples of diamine include aliphatic diamine, alicyclic diamine, aromatic diamine, and aromatic diamine including a heterocyclic ring.

Diamine is not particularly limited as long as diamine is a diamine compound including two amino groups in a molecular structure.

Examples of diamine include aromatic diamine such as p-phenylenediamine, m-phenylenediamine, 4,4′-diaminodiphenylmethane, 4,4′-diaminodiphenylethane, 4,4′-diaminodiphenylether, 4,4′-diaminodiphenyl sulfide, 4,4′-diaminodiphenyl sulfone, 1,5-diaminonaphthalene, 3,3-dimethyl4,4′-diaminobiphenyl, 5-amino1-(4′-aminophenyl)-1,3,3-trimethylindan, 6-amino1-(4′-aminophenyl)-1,3,3-trimethylindan, 4,4′-diaminobenzanilide, 3,5-diamino 3′-trifluoromethylbenzanilide, 3,5-diamino 4′-trifluoromethylbenzanilide, 3,4′-diaminodiphenylether, 2,7-diaminofluorene, 2,2-bis(4-aminophenyl)hexafluoropropane, 4,4′-methylenebis(2-chloraniline), 2,2′,5,5′-tetrachloro4,4′-diaminobiphenyl, 2,2′-dichloro4,4′-diamino 5,5′-dimethoxybiphenyl, 3,3′-dimethoxy 4,4′-diaminobiphenyl, 4,4′-diamino 2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino 2-trifluoromethylphenoxy)phenyl]hexafluoropropane, 4,4′-bis[4-(4-amino 2-trifluoromethyl)phenoxy]-octafkuorobiphenyl; aliphatic diamine and alicyclic diamine such as aromatic diamine 1,1-meta-xylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro4,7-methanoindanylenedimethylenediamine, tricyclo[6,2,1,0^{2.7}]-undecylenedimethyldimethyldiamine, 4,4′-methylenebis(cyclohexylamine) having two amino groups bonded to an aromatic ring such as diaminotetraphenylthiophene and a hetero atom other than a nitrogen atom of the amino groups. One kind of the above diamine may be used alone, or two or more kinds selected therefrom may be used in combination.

The polyetherimide except the siloxane-modified polyetherimide included in the tubular member may be a modified polyetherimide except the siloxane-modified polyetherimide (such as a fluorine-modified polyetherimide or a cyano-modified polyetherimie), or an unmodified polyetherimide is preferably used in terms of solubility with the siloxane-modified polyetherimide and the polyether ether ketone.

Commercially available polyetherimide may also be used, and examples thereof include ULTEM series such as ULTEM 1000, 1010, and 1100 manufactured by SABIC Innovative Plastics.

The content of the polyetherimide in the tubular belt 10 according to the exemplary embodiment is preferably from 25% by weight to 90% by weight, more preferably from 30% by weight to 85% by weight, and further preferably from 40% by weight to 80% by weight with respect to the entire resin components included in the tubular belt in terms of the durability against repeated bending, the dimension stability, and the resistance stability.

Here, the “entire resin components” means the entire resin components included in the tubular member.

### Siloxane-Modified Polyetherimide

The siloxane-modified polyetherimide is a polyetherimide that is obtained by modifying polyetherimide with a silicone resin and has siloxane bond.

Specific examples of the siloxane-modified polyetherimide include a siloxane-modified polyetherimide obtained by modifying the aforementioned polyetherimide with a silicone resin, and for example, a reaction product of aromatic bis (ether anhydride), amine-terminated organosiloxane, and organic diamine is exemplified.

Examples of commercially available siloxane-modified polyetherimide (copolymer of polyetherimide resin and silicone resin) include SILTEM STM 1500, 1600, and 1700 manufactured by SABIC Innovative Plastics.

The content of the siloxane-modified polyetherimide in the tubular belt 10 according to the exemplary embodiment is preferably from 5% by weight to 40% by weight, more preferably from 7.5% by weight to 37.5% by weight, and further preferably from 10% by weight to 35% by weight with respect to the entire resin components included in the tubular belt in terms of the durability against repeated bending, the dimensional stability, and the resistance stability.

The total content A of the siloxane-modified polyetherimide and the polyetherimide except the siloxane-modified polyetherimide in the tubular belt 10 according to the exemplary embodiment is preferably greater than the content B of polyether ether ketone. All the resistance stability, the dimensional stability, and the durability against repeated bending tend to be sufficiently secured by setting the total content of amorphous resin components (that is, all the polyetherimide components) with high dimensional stability and excellent conductive material dispersibility to be greater than the content B of the crystalline resin (that is, polyether ether ketone) that prevents occurrence and propagation of cracking and exhibits high hardness.

From such a viewpoint, a difference (A−B) between the total content A of all the polyetherimide components and the content B of polyether ether ketone is preferably from 5.0% by weight to 90.0% by weight, more preferably from 7.5% by weight to 87.5% by weight, and particularly preferably from 10.0% by weight to 85.0% by weight.

### Polyether Ether Ketone

The polyether ether ketone is a resin in which a benzene ring is connected by an ether bond and a ketone bond. The polyether ether ketone is obtained by bonding hydroquinone and benzophenone having fluorine atoms as a substitution bonded to both terminals through a nucleophilic substitution reaction. Alternatively, the polyether ether ketone is also obtained by bonding benzophenone with a benzene ring having a ketone group with an electrophile (such as chlorine) bonded to both terminals by a Friedel-Crafts reaction using aluminum chloride or the like as a catalyst.

The weight average molecular weight of polyether ether ketone is equal to or greater than 10000, for example, and is preferably equal to or greater than 20000 in terms of strength.

Examples of the commercially available polyether ether ketone include a product commercially available as a polyether ether ketone in a grade of extrusion molding. Specific examples of the commercially available polyether ether ketone include KETASPIRE KT-820 manufactured by Solvay Specialty Polymers Japan K.K and VESTAKEEP manufactured by Dicel-Evonik Ltd.

The content of polyether ether ketone in the tubular belt 10 according to the exemplary embodiment is preferably from 5% by weight to 60% by weight, more preferably from 10% by weight to 50% by weight, and further preferably from 20% by weight to 30% by weight with respect to the entire resin components included in the tubular belt in terms of the hardness of the tubular belt and the dimensional stability.

### Other Resins

The tubular belt 10 according to the exemplary embodiment may contain resin components other than the siloxane-modified polyetherimide, the polyetherimide except the siloxane-modified polyetherimide, and polyether ether ketone.

Examples of the other resins include known thermoplastic resins used in a tubular member such as a polyamide resin (PA), polyether sulphone (PES), polyphenyl sulfone (PPSU), polysulfone (PSF), polyethylene terephthalate (PET), polybutylene terephthalate (PBT), a polyacetal resin (POM), and polycarbonate (PC).

Although the tubular belt 10 according to the exemplary embodiment may include other resins within a range in which the durability against repeated bending does not deteriorate, the total content of the siloxane-modified polyetherimide, the polyetherimide except the siloxane-modified polyetherimide, and the polyether ether ketone is preferably equal to or less than 90% by weight or about 90% by weight, more preferably equal to or less than 95% by weight or about 95% by weight, and particularly preferably 100% by weight or about 100% by weight (that is, the tubular belt 10 does not contain other resins) with respect to the entire resin components in terms of preventing degradation of the durability against repeated bending, the dimensional stability, and the resistance stability due to degradation of solubility.

The resin included in the tubular belt may be identified by performing thermal analysis measurement using differential scanning calorimetry (DSC) on a sample collected from the tubular belt since a crystalline resin such as polyether ether ketone has a unique melting temperature and an amorphous resin such as polyetherimide has a unique glass transition temperature. The content of the resin components included in the tubular belt may be measured by Fourier transform infrared spectroscopy (FTIR).

### Conductive Material

Examples of the conductive material include carbon black; metal such as aluminum and nickel; metal oxides such as yttrium oxide and tin oxide; ion conductive materials such as potassium titanate and potassium chloride; and conductive polymer such as polyaniline, polypyrrol, polysulphone, and polyacetylene. From among these examples, carbon black is preferably used in terms of conductivity and economic efficiency. Carbon black exhibits excellent conductivity, and small content of carbon black may also apply high conductivity.

Examples of carbon black include Ketjen black, oil-furnace black, channel black, acetylene black and carbon black with oxidized surface (hereinafter, referred to as “surface-treated carbon black). From among these examples, the surface-treated carbon black is preferably used in terms of electric resistance stability over time.

The surface-treated carbon black is obtained by applying a carboxyl group, a quinone group, a lactone group, a hydroxyl group, or the like to the surface thereof. Examples of a method of the surface treatment includes an air oxidation method of bringing the carbon black into contact with the air in a high-temperature atmosphere and causing a reaction, a method of causing a reaction with nitrogen oxide or ozone at an ordinary temperature (22° C., for example), and a method of performing air oxidation in a high-temperature atmosphere and then oxidizing a resulting object with ozone at a low temperature.

An average primary particle diameter of the conductive material is preferably equal to or less than 50 nm, more preferably equal to or less than 30 nm, and particularly preferably equal to or less than 25 nm in terms of preventing surface resistivity of the tubular belt 10 from being degraded.

By setting the average primary particle diameter of the conductive material to be equal to or less than 30 nm, a state is obtained in which fine conductive points are achieved by the conducive material with less variations, and a decrease in resistance due to degradation in discharge of the surface of the tubular belt 10. A lower limit of the average primary particle diameter of the conductive material is equal to or greater than 10 nm, and preferably from equal to or greater than 12 nm, for example, in terms of preventing aggregation during dispersion.

The average primary particle diameter of the conductive material included in the tubular belt 10 according to the embodiment is measured by the following method.

First, a measurement sample with a thickness of 100 nm is collected from the obtained tubular belt 10 by a microtome, and the measurement sample is observed by a TEM (transmission electron microscope). Then, diameters of circles equivalent to projection areas of 50 conductive material particles (conductive particles) are regarded as particle diameters, and an average value thereof is regarded as the average primary particle diameter.

The content of the conductive material in the tubular belt 10 is preferably from 10 parts by weight to 30 parts by weight, more preferably from 12 parts by weight to 28 parts by weight, and further preferably from 15 parts by weight to 25 parts by weight with respect to 100 parts by weight of the entire resin components, for example.

If the content of the conductive material in the tubular belt 10 is within the above range, density of the conductive points by the conductive material in the tubular belt 10 increases, and it becomes easier to disperse discharge energy received by the surface of the tubular belt 10. Therefore, degradation is prevented.

If the content of the conductive material is within the above range, the tubular belt 10 may easily obtain target conductivity and may easily form the conductive points at high density in the tubular belt 10. Although there is a concern about brittleness of the tubular belt 10 due to the blending of the conductive material, the tubular belt 10 according to the exemplary embodiment tends not to become brittle even of the content of the conductive material relatively increases since siloxane-modified polyetherimide with flexibility is contained.

In terms of the electric resistance stability over time, pH of the conductive material is preferably equal to or less than 9.0, more preferably equal to or less than 8.0, and further preferably equal to or less than 7.0.

### Other Components

The tubular belt 10 according to the exemplary embodiment may contain components other than the aforementioned components.

Examples thereof include known additives to be blended in a tubular belt for an image forming apparatus, in particular, such as an antioxidant for preventing heat degradation of the tubular belt, a surfactant for enhancing fluidity, and a heat-resistant anti-aging agent. In order to enhance strength, silicone-containing particles such as silicone powder or silicone oil-containing silica may be blended.

Next, description will be given of properties of the tubular belt 10 according to the exemplary embodiment.

The tubular belt 10 according to the exemplary embodiment preferably has surface resistivity from 7 log Ω/square to 13 log Ω/square when measured by applying a voltage of 100 V in an environment at an ordinary temperature and ordinary humidity (temperature: 22° C., and humidity: 55% RH). In a case where the tubular belt 10 is applied as an intermediate transfer belt, in particular, the surface resistivity is preferably from 8 log Ω/square to 12 log Ω/square. If the tubular belt is applied as a transfer belt for transporting a recording medium, the surface resistivity is preferably from 9 log Ω/square to 13 log Ω/square.

The surface resistivity is a value measured by applying a voltage of 100 V in the environment at the ordinary temperature and the ordinary humidity (temperature: 22° C., and humidity: 55% RH).

Here, as for the surface resistivity, a circular electrode (Hiresta IP UR probe manufactured by Mitsubishi Petrochemical Co., Ltd, an outer diameter of a columnar electrode: φ16 mm, an inner diameter of ring-shaped electrode: φ30 mm, outer diameter: φ40 mm) is used, a measurement target is placed on an insulating plate, a target voltage is applied thereto in a target environment, a value of current flowing from the outer diameter to the inner diameter at 5 seconds after the application is measured by using a microammeter R8340A manufactured by Advantest Corporation, and the surface resistivity is obtained from a surface resistance value obtained from the current value based on JIS-K-6911 (1995).

The thickness of the tubular belt according to the exemplary embodiment is not particularly limited and may be selected in accordance with the purpose of use. In a case of using the tubular belt according to the exemplary embodiment as an intermediate transfer belt in an image forming apparatus, for example, the thickness thereof is preferably from 60 μm to 150 μm.

### Method of Manufacturing Tubular Member

A method of manufacturing the tubular member according to the exemplary embodiment is not particularly limited, and may be manufactured by preparing a mixed resin pellet including the siloxane-modified polyetherimide, the polyetherimide except the siloxane-modified polyetherimide, the polyether ether ketone, and the conductive material and melting and extruding the mixed resin pellet into a tubular shape, for example. For the mixed resin pellet, the respective components may be blended in accordance with target surface resistivity, durability against repeated bending, dimensional stability, and the like.

The tubular member may be manufactured by respectively preparing resin pellets that separately contain the conductive material and the respective resin components, and blending, melting, and extruding the respective resin pellets in accordance with target surface resistivity, durability against repeated bending, dimensional stability, and the like.

### Transfer Unit

The tubular belt 10 according to the exemplary embodiment may be preferably applied to a transfer belt (such as an intermediate transfer belt, a transfer belt for transporting a recording medium, or a secondary transfer belt) for an image forming apparatus, for example.

A transfer unit according to the exemplary embodiment includes the aforementioned transfer belt according to the exemplary embodiment and a plurality of rolls over which the transfer belt is stretched in a tension applied state, and is attached to and detached from an image forming apparatus.

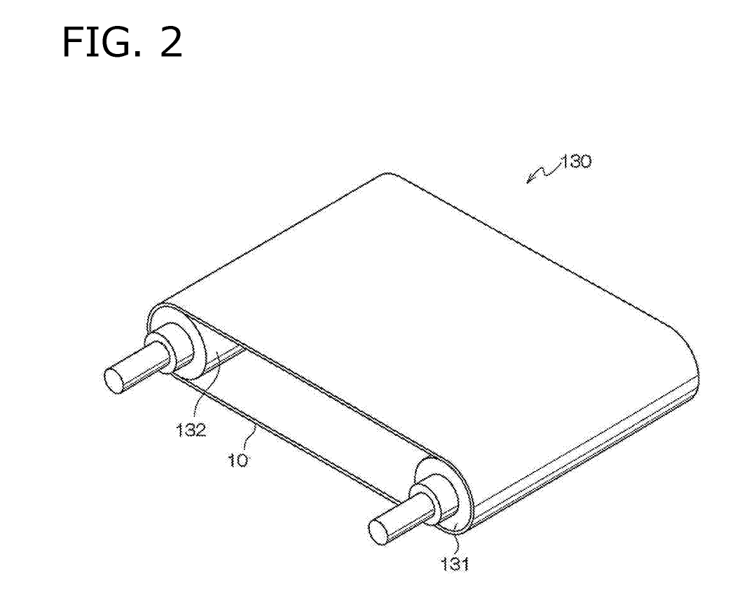

FIG. 2 is a perspective view schematically illustrating the transfer unit according to the exemplary embodiment. A transfer unit 130 according to the exemplary embodiment includes the tubular belt 10 according to the exemplary embodiment as a transfer belt, and for example, the tubular belt 10 is stretched (also referred to “extended” in some cases in the following description) in a state where tension is applied thereto by a driving roll 131 and a driven roll 132 arranged so as to face each other as illustrated in FIG. 2.

Here, in a case where the tubular belt 10 is applied as an intermediate transfer body (intermediate transfer belt) in the transfer unit 130 according to the exemplary embodiment, a roll for primarily transferring a toner image on the surface of a photoreceptor (image holding member) to the tubular belt 10 and a roll for further secondarily transferring the toner image transferred on the tubular belt 10 to a recording medium are arranged as rolls around which the tubular belt 10 is extended.

The number of rolls around which the tubular belt 10 is extended is not limited, and the rolls may be arranged in accordance with a use state. The transfer unit 130 with such a configuration is used while assembled in the apparatus, and rotates in a state where the tubular belt 10 is extended in association with rotation of the driving roll 131 and the driven roll 132.

### Image Forming Apparatus

The image forming apparatus according to the exemplary embodiment includes an image holding member, a charging unit that charges a surface of the image holding member, a latent image forming unit that forms a latent image on the charged surface of the image holding member, a developing unit that develops the latent image on the surface of the image holding member by using a toner and forms a toner image, the aforementioned transfer belt according to the exemplary embodiment, a transfer unit that transfers the toner image formed on the surface of the image holding member to a recording medium, and a fixing unit that fixes the toner image transferred to the recording medium.

Specifically, a configuration of the image forming apparatus according to the exemplary embodiment is exemplified in which the transfer unit includes an intermediate transfer body, a primary transfer unit that primarily transfers a toner image formed on an image holding member to the intermediate transfer body, and a secondary transfer unit that secondarily transfers the toner image transferred to the intermediate transfer body to a recording medium and the tubular belt according to the exemplary embodiment is provided as the intermediate transfer body (intermediate transfer belt), for example.

In addition, a configuration of the image forming apparatus according to the exemplary embodiment is exemplified in which the transfer unit includes a transport transfer body (transport transfer belt) that transports a recoding medium and a transfer unit that transfers a toner image formed on an image holding member to a recording medium transported by a sheet transfer body and the tubular belt according to the exemplary embodiment is provided as the recording medium transfer body (transfer belt for transporting a recording medium).

Examples of the image forming apparatus according to the exemplary embodiment includes an ordinary mono-color image forming apparatus that accommodates only a single-color toner in a developing device, a color image forming apparatus that sequentially repeats primary transfer of a toner image held on an image holding member to an intermediate transfer body, and a tandem-type color image forming apparatus in which a plurality of image holding members provided with developers of the respective colors are arranged in series on an intermediate transfer body.

Hereinafter, description will be given of the image forming apparatus according to the exemplary embodiment with reference to drawings.

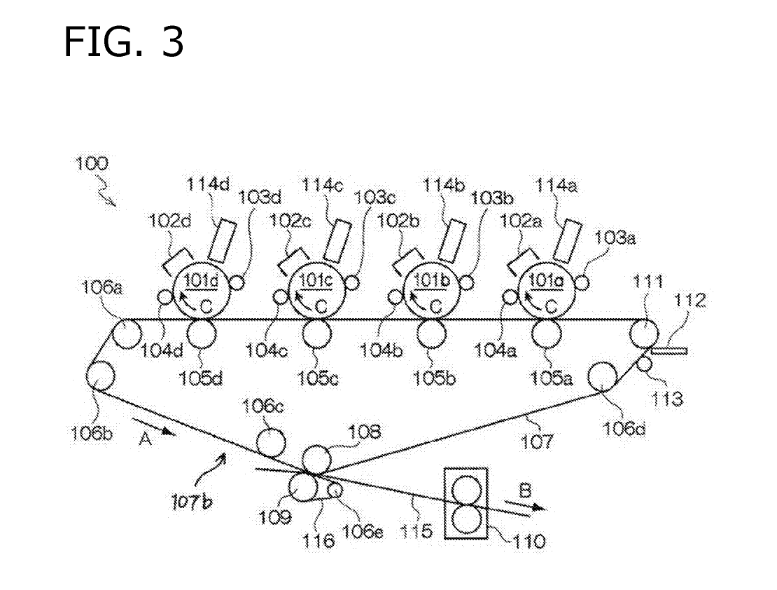

FIG. 3 is a configuration diagram schematically illustrating the image forming apparatus according to the exemplary embodiment.

An image forming apparatus 100 according to the exemplary embodiment is a so-called tandem-type image forming apparatus as illustrated in FIG. 3, and charging devices 102a to 102d, exposure devices 114a to 114d (an example of the latent image forming unit), developing devices 103a to 103d, primary transfer devices (primary transfer rolls) 105a to 105d, and image holding member cleaning devices 104a to 104d are arranged in this order in a circumference of four image holding members 101a to 101d formed of electrophotographic photoreceptors along a rotation direction thereof. In addition, an eraser for removing a potential remaining on the surfaces of the image holding members 101a to 101d after the transfer may be provided.

An intermediate transfer belt 107 is supported while support rolls 106a to 106d, a driving roll 111, and a facing roll 108 apply tension thereto, which forms a transfer unit 107b. The intermediate transfer belt 107 may move the respective image holding members 101a to 101d and the primary transfer rolls 105a to 105d in the direction of the arrow A while the intermediate transfer belt 107 is in contact with the surfaces of the respective image holding members 101a to 101d by the support rolls 106a to 106d, the driving roll 111, and the facing roll 108. A portion at which the primary transfer rolls 105a to 105d are in contact with the image holding members 101a to 101d via the intermediate transfer belt 107 forms a primary transfer unit, and a primary transfer voltage is applied to the contact portion between the image holding members 101a to 101d and the primary transfer rolls 105a to 105d.

As a secondary transfer device, the facing roll 108 and a secondary transfer roll 109 are arranged so as to face each other via the intermediate transfer belt 107 and a secondary transfer belt 116. A recording medium 115 such as a paper moves in the direction of the arrow B in a region interposed between the intermediate transfer belt 107 and the secondary transfer roll 109 while the recording medium 115 is in contact with the surface of the intermediate transfer belt 107, and then passes through a fixing device 110. A portion at which the secondary transfer roll 109 is in contact with the facing roll 108 via the intermediate transfer belt 107 and the secondary transfer belt 116 forms a secondary transfer unit, and a secondary transfer voltage is applied to the contact portion between the secondary transfer roll 109 and the facing roll 108. Furthermore, intermediate transfer belt cleaning devices 112 and 113 are arranged so as to be brought into contact with the intermediate transfer belt 107 after the transfer.

In the multi-color image forming apparatus 100 with such a configuration, an electrostatic latent image of the first color is formed by the exposure device 114a that emits a laser beam, for example, after the image holding member 101a rotates in the direction of the arrow C and the surface thereof is charged by the charging device 102a. The formed electrostatic latent image is developed (visualized) with a toner by the developing device 103a that accommodates toners corresponding to the color, and a toner image is thus formed. The developing devices 103a to 103d accommodates toner (yellow, magenta, cyan, and black, for example) corresponding to electrostatic latent images of the respective colors.

The toner image formed on the image holding member 101a is electrostatically transferred (primarily transferred) to the intermediate transfer belt 107 by the primary transfer roll 105a when the toner image passes through the primary transfer unit. Thereafter, the primary transfer rolls 105b to 105d primarily transfer toner images of the second color, the third color, and the fourth color such that the toner images are sequentially superimposed on the intermediate transfer belt 107 holding the toner image of the first color, and a multi-color overlapped toner image is finally obtained.

The overlapped toner image formed on the intermediate transfer belt 107 is electrostatically and collectively transferred to the recording medium 115 when the overlapped toner image passes through the secondary transfer unit. The recording medium 115 on which the toner image has been transferred is transported to the fixing device 110, is subjected to fixing processing by being heated and pressurized, or heated or pressurized, and is then discharged to the outside of the apparatus.

The residual toners on the image holding members 101a to 101d after the primary transfer are removed by the image holding member cleaning devices 104a to 104d. In contrast, the residual toners on the intermediate transfer belt 107 after the secondary transfer are removed by the intermediate transfer belt cleaning devices 112 and 113 to prepare for a next image formation process.

### Image Holding Member

As the image holding members 101a to 101d, known electrophotographic photoreceptors are widely applied. As the electrophotographic photoreceptors, an inorganic photoreceptor in which a photosensitive layer is made of an inorganic material or an organic photoreceptor in which photosensitive layer is made of an organic material is used. As the organic photoreceptor, a function separate-type organic photoreceptor in which a n electric charge generation layer for generating electric charge by exposure and a charge transport layer for transporting the electric charge are laminated or a single-layer organic photoreceptor that has both a function of generating electric charge and a function of transporting the electric charge is suitably used. As the inorganic photoreceptor, a photoreceptor in which a photosensitive layer is made of amorphous silicon is suitably used.

The shape of each image holding member is not particularly limited, and a known shape such as a cylindrical drum shape, a sheet shape, or a plate shape is employed.

### Charging Device

The charging devices 102a to 102d are not particularly limited, and a known charger such as a contact-type charge using a conductive (a “conductive” charging device described herein means that volume resistivity is less than 10⁷ Ω·cm, for example) or semiconductive (a “semiconductive” charging device means that the volume resistivity is from 10⁷ Ω·cm to 10¹³ Ω·cm, for example) roller, brush, film, rubber blade, or the like, or a scorotron charger or a corotron charger using corona discharge is widely used. From among these examples, the contact-type charge is preferably used.

Although the charging devices 102a to 102d ordinary apply a direct current to the image holding members 101a to 101d, the charging devices 102a to 102d may further apply an alternate current in a superimposed manner.

### Exposure Device

The exposure devices 114a to 114d are not particularly limited, and a known exposure device such as an optical device that may expose the surfaces of the image holding members 101a to 101d with a light source such as a semiconductor laser beam, a light emitting diode (LED) light, or liquid crystal shutter light, or via a polygon mirror from such a light source so as to form a prescribed image is widely used.

### Developing Device

The developing devices 103a to 103d are selected in accordance with a purpose. Examples thereof include a known developing machine that develops an image with a single-component developer or a two-component developer by using a brush, a roller, or the like in a contact or non-contact manner

### Primary Transfer Roll

The primary transfer rolls 105a to 105d may be any of single-layer rolls and multi-layer rolls. In a case of single-layer rolls, for example, the primary rolls 105a to 105d are formed of rolls in which an appropriate amount of conductive particles such as carbon black are blended in foamed or non-foamed silicone rubber, urethane rubber, EPDM, or the like.

### Image Holding Member Cleaning Device

The image holding member cleaning devices 104a to 104d are for removing remaining toners that are attached to the surfaces of the image holding members 101a to 101d after the primary transfer process, and a cleaning blade, brush cleaning, roll cleaning, or the like is used. From among these examples, the cleaning blade is preferably used. Examples of a material of the cleaning blade includes urethane rubber, neoprene rubber, and silicone rubber.

### Secondary Transfer Roll

A layer structure of the secondary transfer roll 109 is not particularly limited, and in a case of a three-layer structure, for example, the layer structure thereof is formed of a core layer, an intermediate layer, and a coating layer that covers the surface thereof. The core layer is formed of a foamed body of silicone rubber, urethane rubber, EPDM, or the like in which conductive particles are dispersed, and the intermediate layer is formed of a non-foamed body of such a material. Examples of a material of the coating layer include tetrafluoroethylene-hexafluoropropylene copolymer and a perfluoroalkoxy resin. The volume resistivity of the secondary transfer roll 109 is preferably equal to or less than 10⁷ Ω·cm. Alternatively, a two-layer structure with the intermediate layer omitted may also be used.

### Facing Roll

The facing roll 108 forms a facing electrode of the secondary transfer roll 109. The facing roll 108 may have any of a single-layer structure and a multi-layer structure. In a case of a single-layer structure, for example, the facing roll 108 is formed of a roll in which an appropriate amount of conductive particles such as carbon black are blended in silicone rubber, urethane rubber, EPDM, or the like. In a case of a two-layer structure, the facing roll 108 is formed of a roll obtained by covering an outer circumferential surface of an elastic layer formed of the above rubber material with a high-resistant layer.

A voltage from 1 kV to 6 kV is typically applied to shafts of the facing roll 108 and the secondary transfer roll 109. The voltage may be applied to the electrode member with satisfactory electric conductivity, which is in contact with the facing roll 108, and the secondary transfer roll 109 instead of the voltage application to the shaft to the facing roll 108. Examples of the electrode member include a metal roll, a conductive rubber roll, a conductive brush, a metal plate, and a conductive resin plate.

### Fixing Device

As the fixing device 110, a known fixer such as a heat roller fixer, a pressurizing roller fixer, or a flash fixer is widely used.

### Intermediate Transfer Belt Cleaning Device

As the intermediate transfer belt cleaning devices 112 and 113, a cleaning blade, brush cleaning, roll cleaning, or the like is used. From among these examples, the cleaning blade is preferably used. Examples of a material of the cleaning blade includes urethane rubber, neoprene rubber, and silicone rubber.

Although the tubular ember according to the exemplary embodiment and the transfer unit and the image forming apparatus using the tubular member according to the exemplary embodiment as a transfer belt were described above, the purpose of the tubular member according to the exemplary embodiment is not limited to the transfer belt. For example, the tubular member may be used as a conductive roll by covering an outer circumferential surface of a cylindrical elastic layer with the tubular member according to the exemplary embodiment.

### EXAMPLES

Although the exemplary embodiment of the invention is specifically described with reference to examples, the exemplary embodiment of the invention is not limited to these examples.

### Example 1

### Production of Mixed Resin Pellet

As the thermoplastic resin, 80 parts by weight of polyetherimide (ULTEM1010V manufactured by SABIC Innovative Plastics), 10 parts by weight of siloxane-modified polyetherimide (SILTEM1500 manufactured by SABIC Innovative Plastics), and 10 parts by weight of polyether ether ketone (VESTAKEEP1000 manufactured by Daicel-Evonik Ltd.) are used. As the conductive material, 20 parts by weight of carbon black (Monark880 manufactured by Cabot Corporation) is used. The three resin components are mixed in advance by using a mixer such that the aforementioned amounts of components are blended.

The mixed resin is put into a twin extrusion melting kneader (twin screw melting kneader L/D60 manufactured by Parker Corporation), carbon black is side-fed to and blended in the melt resin, and melted and kneaded. The kneaded melt is put into a water tank, is cooled, solidified, and then cut, thereby obtaining a mixed resin pellet in which carbon black is blended.

### Production of Tubular Belt

The obtained mixed resin pellet is put into a single screw melting kneader (L/D24, melting extruder manufactured by Mitsuba MFG. Co., Ltd.) (heating temperature: 380° C.), is melt and extruded into a tubular shape from a clearance between a mold die and a nipple set at 350° C. while an outer circumferential surface of a cylindrical inner sizing die controlled at 180° C. is brought into contact with an inner circumferential surface of the molten resin tubular member to cool the tubular member. Then, the tubular member is cut, and a tubular belt 1 with an average film thickness of 120 μm is thus obtained.

### Example 2

A tubular belt 2 is obtained by the same procedure as in Example 1 except that the resin used in producing the mixed resin pellet in Example 1 is changed to 45 parts by weight of polyetherimide (ULTEM1010V manufactured by SABIC Innovative Plastics), 10 parts by weight of siloxane-modified polyetherimide (SILTEM1500 manufactured by SABIC Innovative Plastics), and 45 parts by weight of polyether ether ketone (VESTAKEEP1000 manufactured by Daicel-Evonik Ltd.).

### Example 3

A tubular belt 3 is obtained by the same procedure as in Example 1 except that the resin used in producing the mixed resin pellet in Example 1 is changed to 60 parts by weight of polyetherimide (ULTEM1010V manufactured by SABIC Innovative Plastics), 30 parts by weight of siloxane-modified polyetherimide (SILTEM1500 manufactured by SABIC Innovative Plastics), and 10 parts by weight of polyether ether ketone (VESTAKEEP1000 manufactured by Daicel-Evonik Ltd.).

### Example 4

A tubular belt 4 is obtained by the same procedure as in Example 1 except that the resin used in producing the mixed resin pellet in Example 1 is changed to 30 parts by weight of polyetherimide (ULTEM1010V manufactured by SABIC Innovative Plastics), 10 parts by weight of siloxane-modified polyetherimide (SILTEM1500 manufactured by SABIC Innovative Plastics), and 60 parts by weight of polyether ether ketone (VESTAKEEP1000 manufactured by Daicel-Evonik Ltd.).

### Example 5

A tubular belt 5 is obtained by the same procedure as in Example 1 except that the resin used in producing the mixed resin pellet in Example 1 is changed to 65 parts by weight of polyetherimide (ULTEM1010V manufactured by SABIC Innovative Plastics), 10 parts by weight of siloxane-modified polyetherimide (SILTEM1500 manufactured by SABIC Innovative Plastics), 10 parts by weight of polyether ether ketone (VESTAKEEP1000 manufactured by Daicel-Evonik Ltd.), and 15 parts by weight of polycarbonate (amorphous thermoplastic resin, product name: LEXAN101 manufactured by SABIC Innovative Plastics).

### Comparative Example 1

A tubular belt C1 is obtained by the same procedure as in Example 1 except that the resin used in producing the mixed resin pellet in Example 1 is changed to only 100 parts by weight of polyether imide (ULTEM1010V manufactured by SABIC Innovative Plastics).

### Comparative Example 2

A tubular belt C2 is obtained by the same procedure as in Example 1 except that the resin used in producing the mixed resin pellet in Example 1 is changed to only 100 parts by weight of polyether ether ketone (VESTAKEEP1000 manufactured by Daicel-Evonik Ltd.).

### Evaluation

The tubular belt manufactured in the respective examples are exemplified as follows.

### Surface Resistivity (Before Printing Images)

The surface resistivity (log Ω/square) of the tubular belts obtained in the respective examples is measured by using an Advantest microammeter (UR probe/100 V/load: 2 kg/10 seconds). Here, the measurement is performed in an environment at a temperature of 22° C. and humidity of 55% RH.

### Durability Against Repeated Bending (MIT Test)

Test method: based on JIS-P8115 (MIT tester, sample width: 15 mm, the number of times of durability until fracture under tensile load of 1 kg)

The tubular belts obtained in the respective examples are cut into strip-shaped samples with a width direction of 15 mm and a length of 200 mm in a circumferential direction. Both ends of each strip-shaped sample are fixed, tensile force of 1 kgf is applied thereto, and the sample is repeatedly bent (folded) in a horizontally 90° direction about a terminal with a curvature shape R3 as a support point. At this time, the number of times of the bending until the sample fractures is evaluated as the number of times of bending resistance. Here, the above test is conducted in an environment at an ordinary temperature and ordinary humidity (temperature: 22° C., humidity: 45% RH). A: No fracture occurs even after the sample is bent 10000 times. B: Fracture occurs after the sample is bent from 2000 times to 10000 times. C: Fracture occurs after the sample is bent less than 2000 times.

### Dimensional Stability (Influences of Temperature and Humidity)

Each of the tubular belts obtained in the respective examples is mounted as an intermediate transfer belt on an image forming apparatus “DocuPrint C2250” manufactured by Fuji Xerox Co., Ltd. After leaving the tubular belt in an environment at 40° C. and 95% RH for 100 hours, 1000 halftone (magenta 30%) images are printed on A5 sheets in an environment at 10° C. and 10% RH, and influences of deformation and the like of the intermediate transfer belt on image quality are checked. Here, the 10th image and the 1000th image are visually compared, and image quality is evaluated based on the following criteria. A: No decrease in image density is observed. B: Slight decrease in image density is observed. C: Decrease in image density is observed (unallowable level).

### Evaluation of Image Quality in Environment at Low Temperature and Low Humidity

Each of the tubular belts obtained in the respective examples is mounted as an intermediate transfer belt on an image forming apparatus “DocuPrint C2250” manufactured by Fuji Xerox Co., Ltd. In a low-temperature low-humidity environment at 10° C. and 10% RH (an environment in which discharge tends to occur in association with peeling-off of the surface of the intermediate transfer belt from the sheets during the transfer), 50000 halftone (magenta 30%) images are printed on A5 sheets. Here, the 10th image and the 50th image are visually compared, and image quality is evaluated based on the following criteria. A: No decrease in image density is observed. B: Slight decrease in image density is observed. C: Decrease in image density is observed (unallowable level).

Surface Resistivity (after Printing Images)

The surface resistivity (log Ω/square) of each tubular belt (intermediate transfer belt) after printing the 50000 images in the aforementioned environment at a low temperature and low humidity is measured in the same manner as the surface resistivity before printing the images (ordinary temperature and ordinary humidity (22° C., 55% RH, applied voltage: 100 V).

The amounts (weight ratio) of the blended resin and the conductive material that are used in the respective examples and evaluation results will be shown below in Table 1.

TABLE 1

| | | | | | | | | Comparative | Comparative |
|---|---|---|---|---|---|---|---|---|---|
| | | | Example 1 | Example 2 | Example 3 | Example 4 | Example 5 | Example 1 | Example 2 |
| Resin | Polyetherimide | | 80 | 45 | 60 | 30 | 65 | 100 | 0 |
| | Siloxane-modified | | 10 | 10 | 30 | 10 | 10 | 0 | 0 |
| | polyetherimide | | | | | | | | |
| | Polyether ether ketone | | 10 | 45 | 10 | 60 | 10 | 0 | 100 |
| | Polycarbonate | | 0 | 0 | 0 | 0 | 15 | 0 | 0 |
| Conducive | Carbon black | | 20 | 20 | 20 | 20 | 20 | 20 | 20 |
| agent | | | | | | | | | |
| Evaluation | Surface | Before | 10.6 | 10.4 | 10.9 | 10.2 | 10.5 | 10.6 | 10.1 |
| | Resistivity | printing | | | | | | | |
| | (logΩ/square) | image | | | | | | | |
| | | After | 10.4 | 10.1 | 10.8 | 10 | 10.4 | 9.9 | 7.8 |
| | | printing | | | | | | | |
| | | images | | | | | | | |

| | | | | | | | |
|---|---|---|---|---|---|---|---|
| Durability against repeated | A | A | A | A | B | C | B |
| bending (result of MIT test) | | | | | | Fracture | |
| | | | | | | occurred after | |
| | | | | | | bending1500 | |
| | | | | | | times | |
| Evaluation of image quality | A | A | A | A | A | B | C |
| in low-temperature low- | | | | | | | |
| humidity environment | | | | | | | |
| Dimensional stability | A | A | A | B | A | B | C |
| (Evaluation of image quality | | | | | | | |
| in actual apparatus after | | | | | | | |
| storage in high-temperature | | | | | | | |
| high-humidity environment) | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A tubular member comprising:
a siloxane-modified polyetherimide,
a polyetherimide except the siloxane-modified polyetherimide,
a polyether ether ketone, and
a conductive material.

2. The tubular member according to claim 1,
wherein a total content (% by weight) of the siloxane-modified polyetherimide and the polyetherimide except the siloxane-modified polyetherimide is greater than a content (% by weight) of the polyether ether ketone.

3. The tubular member according to claim 1,
wherein a total content of the siloxane-modified polyetherimide, the polyetherimide except the siloxane-modified polyetherimide, and the polyether ether ketone is equal to or greater than about 90% by weight of a total content of all the resin components.

4. The tubular member according to claim 2,
wherein a total content of the siloxane-modified polyetherimide, the polyetherimide except the siloxane-modified polyetherimide, and the polyether ether ketone is equal to or greater than about 90% by weight of a total content of all the resin components.

5. A transfer belt comprising: the tubular member according to claim 1.

6. A transfer unit comprising: the transfer belt according to claim 5; and a plurality of rolls over which the transfer belt is stretched in a state where tension is applied thereto, wherein the transfer unit is detachable from an image forming apparatus.

7. An image forming apparatus comprising:
an image holding member;
a charging unit that charges a surface of the image holding member;
a latent image forming unit that forms a latent image on the charged surface of the image holding member;
a developing unit that develops the latent image on the surface of the image holding member by using a toner to form a toner image;
a transfer unit that includes the transfer belt according to claim 5 and transfers the toner image formed on the surface of the image holding member to a recording medium; and
a fixing unit that fixes the toner image transferred to the recording medium.
